(19) United States
(12) Patent Application Publication
(10) Pub. No.: US 2015/0042611 A1
(43) Pub. Date: Feb. 12, 2015

(54) TOUCH ELECTRONIC DEVICE

(71) Applicant: National Taiwan University, Taipei (TW)

(72) Inventors: Ren-Chyuan LUO, Taipei (TW); Cheng-Jan CHI, Taipei (TW)

(21) Appl. No.: 14/452,980

(22) Filed: Aug. 6, 2014

(30) Foreign Application Priority Data
Aug. 8, 2013 (TW) 102128520

(51) Int. Cl. G06F 3/044

(52) U.S. Cl. CPC G06F 3/044
USPC 345/174

(57) ABSTRACT

A touch electronic device includes a touch panel and a tactile identifying film including a plurality of tactile identifying patterns. At least an opening is formed in each of the tactile identifying patterns for exposing a portion of a touch surface of the touch panel. A user touches the touch surface through the opening. Moreover, another touch electronic device includes a touch panel and a tactile identifying film is also provided. Tactile identifying patterns of the tactile identifying film are made of piezoelectric material or conductive material, so that the touch panel is capable of sensing a pressing action when the tactile identifying pattern is pressed.

### FIELD OF THE INVENTION

The present invention relates to touch electronic devices, and more particularly to a touch electronic device for visually impaired people.

### BACKGROUND OF THE INVENTION

Since it is easy to operate a touch electronic device, touch electronic devices become more and more popular. In order to make it is possible that visually impaired people can operate a touch electronic device, a tactile identifying cover is added to the touch electronic device.

FIG. 1 is a schematic view of a convention electronic device for visually impaired people. Referring to FIG. 1, a convention touch electronic device 100 includes a touch panel and a tactile identifying cover 120. The tactile identifying cover 120 covers the touch panel, and includes a plurality of tactile identifying patterns 122. Visually impaired people could operate the electronic device 100 by pressing the tactile identifying patterns 122.

Principle of sensing of a capacitive touch panel is that: an electric field is formed by a conductive layer of the capacitive touch panel, thus, when a conductive object (eg., finger) contact the touch panel, capacitive coupling is generated, the conductive object bring away small current, so that the position of the touch point can be determined according to the change of current. Therefore, the object used to contact the capacitive touch panel should be conductive. However, since the tactile identifying cover 120 is non-conductive, the tactile identifying cover 120 can not used in cooperation with a capacitive touch panel.

### SUMMARY OF THE INVENTION

The present invention provides a touch electronic device, wherein the electronic device has a tactile identifying film in cooperation with a capacitive touch panel.

To achieve at least one of above advantages, a touch electronic device is provided according to an embodiment of the present invention. The touch electronic device includes a touch panel and a tactile identifying film. The touch panel includes a touch surface. The tactile identifying film covers at least the touch surface of the touch panel. The tactile identifying film includes a plurality of tactile identifying patterns defined in the touch surface. Each tactile identifying pattern defines an opening to partially expose the touch surface.

In an embodiment of the present invention, the touch panel includes a capacitive touch panel.

To achieve at least one of above advantages, another touch electronic device is provided according to another embodiment of the present invention. The touch electronic device includes a touch panel and a tactile identifying film. The touch panel includes a touch surface. The tactile identifying film covers at least the touch surface of the touch panel. The tactile identifying film includes a plurality of tactile identifying patterns defined in the touch surface. The tactile identifying patterns include piezoelectric material.

In an embodiment of the present invention, the tactile identifying film further includes an insulation main body, the insulation main body defines a plurality of through holes, and the tactile identifying patterns are disposed in the through holes respectively.

To achieve at least one of above advantages, another touch electronic device is provided according to another embodiment of the present invention. The touch electronic device includes a touch panel and a tactile identifying film. The touch panel includes a touch surface. The tactile identifying film covers at least the touch surface of the touch panel. The tactile identifying film includes a plurality of tactile identifying patterns defined in the touch surface. The tactile identifying patterns include conductive material.

In an embodiment of the present invention, the tactile identifying film further includes an insulation main body, the tactile identifying patterns are inlaid in the insulation main body, each tactile identifying pattern includes a first conductive sheet, a second conductive sheet and a conductive connection portion, the first conductive sheet and the second conductive sheet are respectively disposed at two oppose sides of the insulation main body, the conductive connection portion is positioned between and connects the first conductive sheet and the second conductive sheet.

In an embodiment of the present invention, the tactile identifying film further includes an insulation main body, the tactile identifying patterns are inlaid in the insulation main body, each tactile identifying pattern includes at least one column body passing through the insulation main body.

In an embodiment of the present invention, the tactile identifying film further includes an insulation main body, the insulation main body defines a plurality of through holes, the tactile identifying patterns are disposed in the through holes respectively, each tactile identifying pattern includes a first conductive sheet and a second conductive sheet; the first conductive sheet and the second conductive sheet are disposed separately from each other, opposed to each other; the second conductive sheet is adjacent to the touch surface, and the first conductive sheet is suitable to be deformed to touch the second conductive sheet while a pressure is given thereon.

In an embodiment of the present invention, the tactile identifying film further includes an insulation main body, and each tactile identifying pattern includes a plurality conductive particles disposed in the insulation main body.

In one embodiment, since each tactile identifying pattern defines an opening to partially expose the touch surface, so that even the touch panel is a capacitive touch panel, user can touch the touch surface via the opening to operate the capacitive touch panel. In other embodiment, since each tactile identifying pattern includes conductive material or piezoelectric material, a current is generated when the tactile identifying pattern is pressed. Even the touch panel is a capacitive touch panel, user can operate the capacitive touch panel by pressing the tactile identifying pattern.

### BRIEF DESCRIPTION OF THE DRAWINGS

The present invention will become more readily apparent to those ordinarily skilled in the art after reviewing the following detailed description and accompanying drawings, in which:

FIG. 1 is a schematic view of a convention touch electronic device for visually impaired people;

FIG. 2 is a schematic view of a touch electronic device according to an embodiment of the present invention;

FIG. 3 is a schematic, cross-sectional view taken along line A-A of FIG. 2;

FIG. 4 is a schematic, partially cross-sectional view of a touch electronic device according to another embodiment of the present invention;

FIG. 5 is a schematic, partially cross-sectional view of a touch electronic device according to another embodiment of the present invention;

FIG. 6 is a schematic, partially cross-sectional view of a touch electronic device according to another embodiment of the present invention;

FIG. 7 is a schematic, partially cross-sectional view of a touch electronic device according to another embodiment of the present invention;

FIG. 8 shows a tactile identifying patterns of the electronic device shown in FIG. 7 being pressed;

FIG. 9 is a schematic, partially cross-sectional view of a touch electronic device according to another embodiment of the present invention.

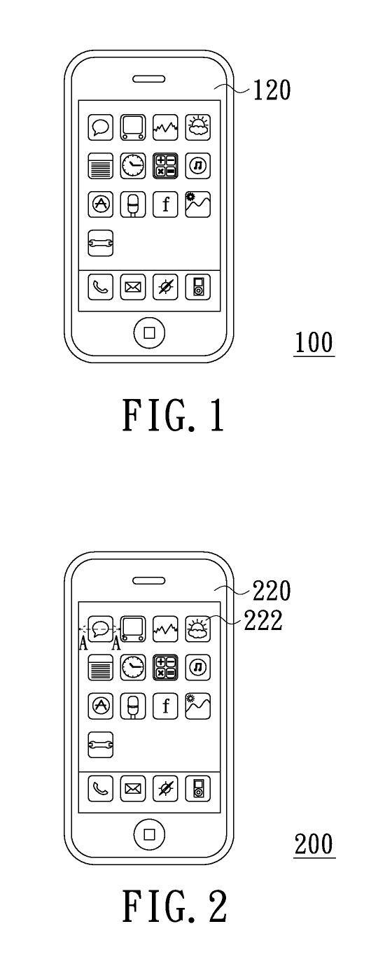

### DETAILED DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

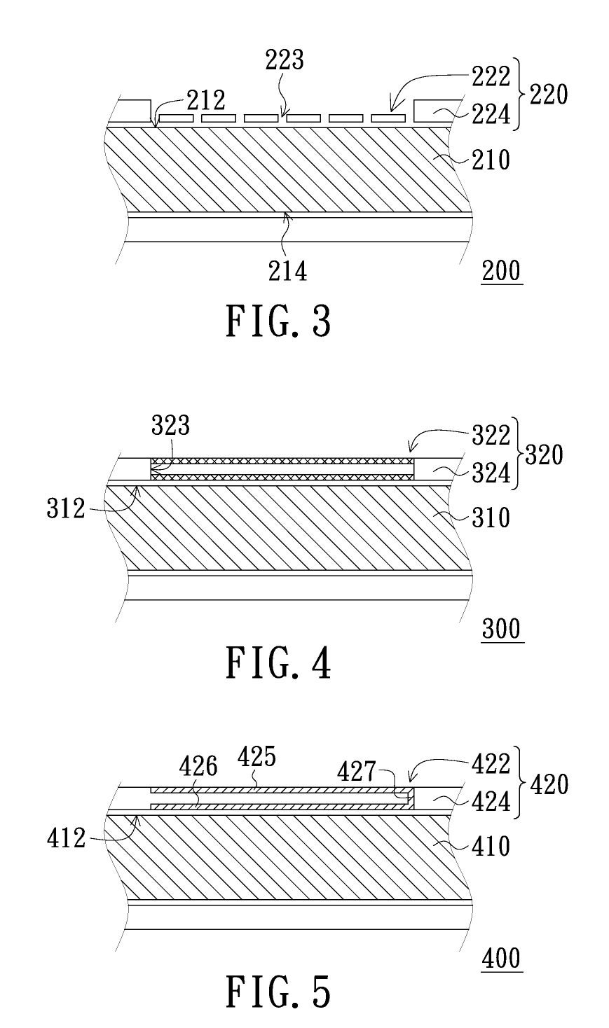

FIG. 2 is a schematic view of a touch electronic device according to an embodiment of the present invention. FIG. 3 is a schematic, cross-sectional view taken along line A-A of FIG. 2. Referring to FIGS. 2 and 3, in this embodiment, the touch electronic device 200 includes a touch panel 210 a tactile identifying film 220. The touch panel 210 includes a touch surface 212. The tactile identifying film 220 at least covers the touch surface 212 of the touch panel 210. The tactile identifying film 220 defines a plurality of tactile identifying patterns 222 in the touch surface 212. Each tactile identifying pattern 222 defines at least one opening 223 (in this embodiment, there are a plurality of openings 223), so as to partially dispose the touch surface 212.

In this embodiment, the tactile identifying film 220 further includes an insulation main body 224, and the tactile identifying patterns 222 are formed in the insulation main body 224. The insulation main body 224 extends to cover a back surface 214 of the touch panel 210. The tactile identifying patterns 222 of the tactile identifying film 220 respectively have their specific patterns, so that users can identified these tactile identifying patterns 222 by touch. Each tactile identifying pattern 222 may instead of a function key, so that user can operate the touch electronic device 200 by pressing the tactile identifying patterns 222. Thus, the touch electronic device 200 according to this embodiment can be used by visually impaired people.

In this embodiment, sine each tactile identifying pattern 222 defines an opening 223, a finger could touch the touch surface 212 via the opening 223 while it pressing the tactile identifying pattern 222. Thus, even the touch panel 210 is a capacitive touch panel, when a finger presses the tactile identifying pattern 222, capacitive coupling also can be generated to produce a current touch operation to achieve the effect. In this embodiment, the touch panel 210 may purely have touch function, or have touch function and display function at the same time.

FIG. 4 is a schematic, partially cross-sectional view of a touch electronic device according to another embodiment of the present invention. Referring to FIG. 4, in this embodiment, the touch electronic device 300 includes a touch panel 310 and a tactile identifying film 320. The configuration of the tactile identifying film 320 in this embodiment is similar to the tactile identifying film 220 in above embodiment, except that the tactile identifying patterns 322 of the tactile identifying film 320 do not have openings to expose the touch surface 312 of the touch panel 310, and the tactile identifying patterns 322 of the tactile identifying film 320 include piezoelectric material.

In more details, the tactile identifying film 320 further includes an insulation main body 324. The insulation main body 324 defines a plurality of through holes 323 (FIG. 4 just shows one). The tactile identifying patterns 322 are disposed in the through holes 323 respectively. In other words, each through hole 323 has one tactile identifying pattern 322 disposed therein. Since the tactile identifying patterns 322 include piezoelectric material, when one of the tactile identifying patterns 322 is pressed to touch the touch surface 312, electric charge of the piezoelectric material transfer to generate current. Thus, even the touch panel 310 is a capacitive touch panel, when a finger presses one of the tactile identifying patterns 322, capacitive coupling also can be generated to produce a current touch operation to achieve the effect.

FIG. 5 is a schematic, partially cross-sectional view of a touch electronic device according to another embodiment of the present invention. Referring to FIG. 5, in this embodiment, the touch electronic device 400 includes a touch panel 410 and a tactile identifying film 420. The configuration of the tactile identifying film 420 in this embodiment is similar to the tactile identifying film 320 in above embodiment, except that the tactile identifying patterns 422 of the tactile identifying film 420 include piezoelectric material.

In more details, the tactile identifying film 420 further includes an insulation main body 424. The tactile identifying patterns 422 are inlaid in the insulation main body 424. Each tactile identifying pattern 422 includes a first conductive sheet 425, a second conductive sheet 426 and a conductive connection portion 427. The first conductive sheet 425 and the second conductive sheet 426 are respectively disposed at two oppose sides of the insulation main body 424. The conductive connection portion 427 is positioned between the first conductive sheet 425 and the second conductive sheet 426, and connects the first conductive sheet 425 and the second conductive sheet 426. The second conductive sheet 426 is disposed adjacent to the touch surface 412 of the touch panel 410. The first conductive sheet 425 is suitable to be identified by touch and to be pressed by users.

Since the tactile identifying patterns 422 include conductive material, when one of the tactile identifying patterns 422 is pressed to touch the touch surface 412, electric charge in the tactile identifying pattern 422 transfer to generate current. Thus, even the touch panel 410 is a capacitive touch panel, when a finger presses one of the tactile identifying patterns 422, capacitive coupling also can be generated to produce a current touch operation to achieve the effect.

In each of the flowing embodies, the tactile identifying patterns of the tactile identifying film include conductive material, and the configure of the touch electronic device is similar to the touch electronic device 400, except the configure of the tactile identifying film.

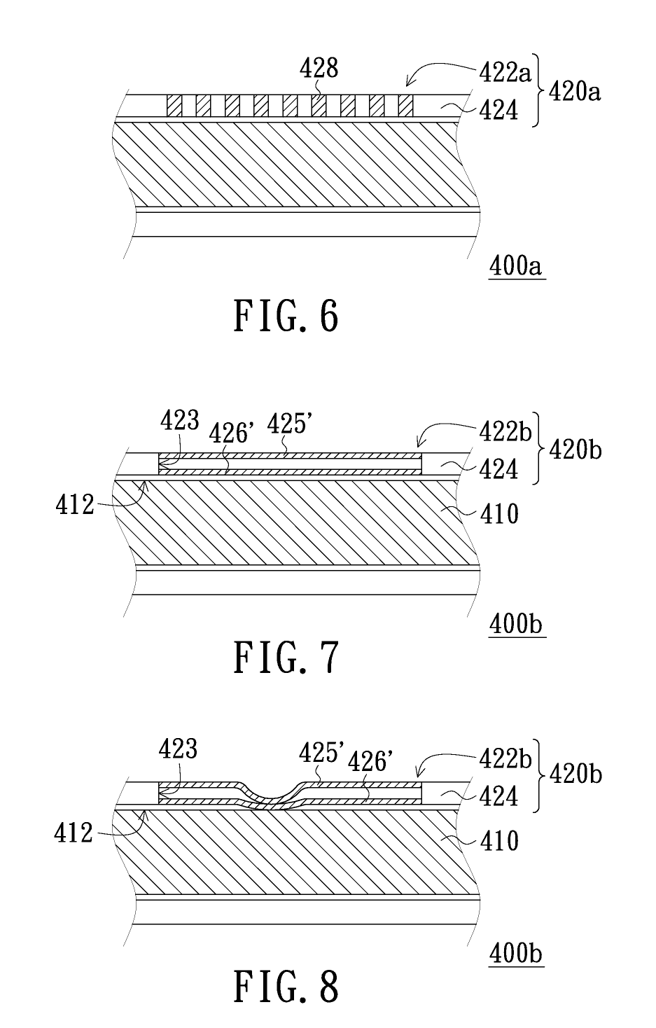

FIG. 6 is a schematic, partially cross-sectional view of a touch electronic device according to another embodiment of the present invention. Referring to FIG. 6, according to the touch electronic device 400a of this embodiment, each tactile identifying pattern 422a of the tactile identifying film 420a includes at least one column body 428 extending through the insulation main body 424 (FIG. 6 shows a plurality of column bodies 428).

FIG. 7 is a schematic, partially cross-sectional view of a touch electronic device according to another embodiment of the present invention. FIG. 8 shows one of the tactile identifying patterns of the electronic device shown in FIG. 7 being pressed. Referring to FIG. 7, according to the touch electronic device 400b of this embodiment, the insulation main body 424 of the tactile identifying film 420b defines a plurality of through holes 423 (FIG. 7 just show one). The tactile identifying patterns 420b are respectively disposed in the through holes 423. In other words, each through hole 423 has a tactile identifying pattern 420b therein. Each tactile identifying pattern 420b includes a first conductive sheet 425′ and a second conductive sheet 426′. The first conductive sheet 425′ and the second conductive sheet 426′ are disposed separately from each other, opposed to each other. The second conductive sheet 426′ is adjacent to the touch surface 412, and the first conductive sheet 425′ is suitable to be deformed to touch the second conductive sheet 426′ while a pressure is given thereon.

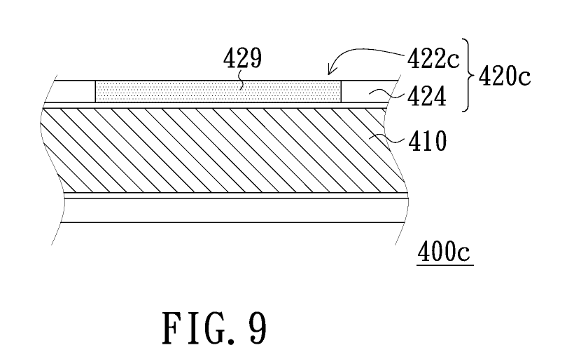

FIG. 9 is a schematic, partially cross-sectional view of a touch electronic device according to another embodiment of the present invention. Referring to FIG. 9, according to the touch electronic device 400c of this embodiment, each tactile identifying pattern 422c of the tactile identifying film 420c includes a plurality of conductive particles 429 in the insulation main body 424. When one of the tactile identifying patterns 422c is compressed, some conductive particles 429 get conduction therebetween to generate current, so that the touch electronic device 400c get a current touch operation to achieve the effect.

In summary, in one embodiment, since each tactile identifying pattern defines an opening to partially expose the touch surface, so that user can touch the touch surface via the opening to operate the capacitive touch panel. In other embodiment, since each tactile identifying pattern includes conductive material or piezoelectric material, a current is generated when the tactile identifying pattern is pressed, and the capacitive touch panel can be operated by this way.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A touch electronic device, comprising:
a touch panel, including a touch surface; and
a tactile identifying film, covering at least the touch surface of the touch panel, the tactile identifying film including a plurality of tactile identifying patterns defined in the touch surface, and each tactile identifying pattern defining an opening to partially expose the touch surface.

2. The touch electronic device as claimed in claim 1, wherein the touch panel comprises a capacitive touch panel.

3. A touch electronic device, comprising:
a touch panel, including a touch surface; and
a tactile identifying film, covering at least the touch surface of the touch panel, the tactile identifying film including a plurality of tactile identifying patterns defined in the touch surface, and the tactile identifying patterns including piezoelectric material.

4. The touch electronic device as claimed in claim 3, wherein the tactile identifying film further comprises an insulation main body, the insulation main body defines a plurality of through holes, and the tactile identifying patterns are disposed in the through holes respectively.

5. The touch electronic device as claimed in claim 3, wherein the touch panel comprises a capacitive touch panel.

6. A touch electronic device, comprising:
a touch panel, including a touch surface; and
a tactile identifying film, covering at least the touch surface of the touch panel, the tactile identifying film including a plurality of tactile identifying patterns defined in the touch surface, and the tactile identifying patterns including conductive material.

7. The touch electronic device as claimed in claim 6, wherein the tactile identifying film further comprises an insulation main body, the tactile identifying patterns are inlaid in the insulation main body, each tactile identifying pattern comprises a first conductive sheet, a second conductive sheet and a conductive connection portion, the first conductive sheet and the second conductive sheet are respectively disposed at two oppose sides of the insulation main body, the conductive connection portion is positioned between and connects the first conductive sheet and the second conductive sheet.

8. The touch electronic device as claimed in claim 6, wherein the tactile identifying film further comprises an insulation main body, the tactile identifying patterns are inlaid in the insulation main body, each tactile identifying pattern comprises at least one column body passing through the insulation main body.

9. The touch electronic device as claimed in claim 6, wherein the tactile identifying film further comprises an insulation main body, the insulation main body defines a plurality of through holes, the tactile identifying patterns are disposed in the through holes respectively, each tactile identifying pattern comprises a first conductive sheet and a second conductive sheet, the first conductive sheet and the second conductive sheet are disposed separately from each other and opposed to each other, the second conductive sheet is adjacent to the touch surface, and the first conductive sheet is suitable to be deformed to touch the second conductive sheet while a pressure is given thereon.

10. The touch electronic device as claimed in claim 6, wherein the tactile identifying film further comprises an insulation main body, and each tactile identifying pattern comprises a plurality conductive particles disposed in the insulation main body.

11. The touch electronic device as claimed in claim 6, wherein the touch panel comprises a capacitive touch panel.
